(19) United States
(12) Patent Application Publication
(10) Pub. No.: US 2012/0044091 A1
(43) Pub. Date: Feb. 23, 2012

(54) METHOD AND APPARATUS FOR PROVIDING PARKING MANAGEMENT SERVICE, AND CLIENT DEVICE AND SERVER THEREFOR

(75) Inventors: Sang Cheol KIM, Daejeon (KR); Hae Yong Kim, Daejeon (KR); Pyeong Soo Mah, Daejeon (KR)

(73) Assignee: Electronics and Telecommunications Research Institute, Daejeon (KR)

(21) Appl. No.: 13/212,939

(22) Filed: Aug. 18, 2011

(30) Foreign Application Priority Data
Aug. 20, 2010 (KR) 10-2010-0081037

(51) Int. Cl. B60Q 1/48

(52) U.S. Cl. 340/932.2

(57) ABSTRACT

An apparatus for providing a parking management service includes: a client terminal for providing a user with a parking management service in a parking lot by using communication environment; a first sensor node, installed in a parking area in the parking lot, for sensing whether there is a vehicle in the parking area; a second sensor node, installed at a vehicle movement section in the parking lot, for sensing a vehicle moving in the parking area; and a parking management server for receiving sensing information from the first and second sensor nodes, generating real-time parking lot information, and providing the generated real-time parking lot information to the client terminal. The apparatus further includes a network provided among the client terminal, the first sensor node, the second sensor node and the parking management server for transmitting information for a parking management.

### CROSS-REFERENCE(S) TO RELATED APPLICATION(S)

The present invention claims priority of Korean Patent Application No. 10-2010-0081037 filed on Aug. 20, 2010, which is incorporated herein by reference.

### FIELD OF THE INVENTION

The present invention relates to a parking management service, and more particularly, to a method and an apparatus for effectively providing a parking management service to a vehicle entering a parking lot, a client terminal and a server for the parking management service.

### BACKGROUND OF THE INVENTION

With the wide usage of navigation terminals, drivers (users) can easily reach a desired destination without having to search for a map in advance. However, currently, navigation terminals guide vehicles merely before entering a parking lot and does not provide a guide service within the parking lot, e.g., displaying an overall map of the parking lot in detail, searching for an empty parking area in the parking lot, or the like. Accordingly, if the parking lot where he or she first visits is very large or has a complicated structure, a driver may not easily draw the entire parking lot, and the driver may hardly find the location where he or she parked.

Although some navigation terminals guide an internal structure of a parking lot, a driver still needs to locate a parking area based on a guide sign board in the parking lot. Thus, if the driver fails to discover the guide sign board or mistakenly take it, the driver cannot properly find an empty parking area.

Further, in the conventional parking lot system using a navigation terminal, a driver needs to reserve an available parking area in advance by using the navigation terminal, causing user inconvenience. Thus, it is practically unrealistic for an actual parking lot system in which parking areas are required to be managed in real time.

Also, in the conventional parking guide service, only the number of remaining parking areas is informed, and therefore, a driver can hardly recognize where the remaining parking areas exist in a parking lot. Even if a parking area is secured, merely a uniform service is provided without consideration of the size of a vehicle, driver's parking abilities, driver's preferences or the like. Further, the information on the remaining parking areas does not include real-time information revealing whether a vehicle has just driven out from a parking area or not.

In addition, although a sign board guiding a parking available area by numbers, arrows, or the like, is installed in a parking lot, when there are several directions at a fork, or when a parking lot has a complicated structure, it may confuse a driver and take long time to find a proper parking area. Further, a problem in terms of management may arise in a situation in which the sign board is broken down, or the like.

### SUMMARY OF THE INVENTION

In view of the above, the present invention provides a method and an apparatus for providing a parking management service in which sensor nodes are installed at parking areas and along a proceeding path in a parking lot, thus easily recognizing a vehicle movement and the presence and absence of a vehicle therein.

The present invention further provides a client terminal and a parking management server which are associated through a network in a parking lot, thus effectively guiding an available parking area.

In accordance with a first aspect of the present invention, there is provided an apparatus for providing a parking management service including: a client terminal for providing a user with a parking management service in a parking lot by using communication environment; a first sensor node, installed in a parking area in the parking lot, for sensing whether or not there is a vehicle in the parking area; a second sensor node, installed at a vehicle movement section in the parking lot, for sensing a vehicle moving in the parking area; a parking management server for receiving sensing information from the first and second sensor nodes, generating real-time parking lot information by processing the received sensing information, and providing the generated real-time parking lot information to the client terminal; and a network for transmitting information for a parking management among the client terminal, the first sensor node, the second sensor node and the parking management server.

In accordance with a second aspect of the present invention, there is provided a client terminal provided in a vehicle for a parking management service including: a communication unit for downloading map information regarding a parking lot or real-time parking lot information and transmitting status information on the vehicle to a parking management server, when the vehicle arrives at the parking lot; a storage unit for temporarily storing the map information and the real-time parking lot information; a display unit for displaying the map information, parking lot guide information and/or real-time parking lot information; and a controller for controlling the display unit to display the map information, real-time parking lot information provided through the communication unit or the parking lot guide information generated based on the map information and controlling the communication unit to transmit the status information to the parking management server.

In accordance with a third aspect of the present invention, there is provided a server for a parking management service including: a communication unit for providing a communication environment between a client terminal and a first and a second sensor nodes through a network; a parking lot information management unit for managing the communication unit to transmit a map regarding a parking lot to the client terminal, generating real-time parking lot information by processing parking available information and vehicle movement information received through the communication unit, and managing the communication unit to transmit the generated real-time parking lot information to the client terminal through the communication unit; and a parking lot map database for storing the map.

In accordance with a fourth aspect of the present invention, there is provided a method for providing a parking management service including: when a vehicle including a client terminal arrives at a parking lot, downloading map information regarding the parking lot and real-time parking lot information; displaying the downloaded map information and real-time parking lot information; and when a certain available parking area is selected based on the real-time parking lot information, starting a route guide to the selected available parking area.

In accordance with a fifth aspect of the present invention, there is provided a method for providing a parking management service including: transmitting a parking lot map to a client terminal equipped in a vehicle entering a parking lot; receiving parking available information and vehicle movement information from sensor nodes installed in a parking area and a vehicle moving area in the parking lot, respectively; storing the parking available information and vehicle movement information as real-time parking lot information; and when the real-time parking lot information is requested by the client terminal, transmitting the stored real-time parking lot information to the client terminal.

### BRIEF DESCRIPTION OF THE DRAWINGS

The objects and features of the present invention will become apparent from the following description of embodiments, given in conjunction with the accompanying drawings, in which:

FIG. 1 shows a block diagram of an apparatus for providing a parking management service in accordance with an embodiment of the present invention;

FIG. 2 illustrates a detailed block diagram of a client terminal in the client terminal group of FIG. 1;

FIG. 3 presents a detailed block diagram of the parking management server of FIG. 1;

FIG. 4 provides a block diagram of a sensor node, i.e., a vehicle presence/absence sensor, in a sensor node group of FIG. 1;

FIG. 5 depicts a block diagram of any sensor node, i.e., a vehicle movement sensor, in the sensor node group of FIG. 1;

FIG. 6 is a flow chart illustrating a parking management process by a client terminal in a method for providing a parking management service in accordance with an embodiment of the present invention;

FIGS. 7 to 10 show a parking management service image displayed on a client terminal in the parking management service process of FIG. 6;

FIG. 11 is a flow chart illustrating a parking management process by a parking management server in the method for providing a parking management service in accordance with the embodiment of the present invention;

FIG. 12 is a flow chart illustrating a sensing process by a sensor node including a vehicle presence/absence sensor, in the method for providing a parking management service in accordance with the embodiment of the present invention; and

FIG. 13 is a flow chart illustrating a sensing process by a sensor node including a vehicle movement sensor, in the method for providing a parking management service in accordance with the embodiment of the present invention.

### DETAILED DESCRIPTION OF THE EMBODIMENTS

Hereinafter, embodiments of the present invention will be described in detail with the accompanying drawings.

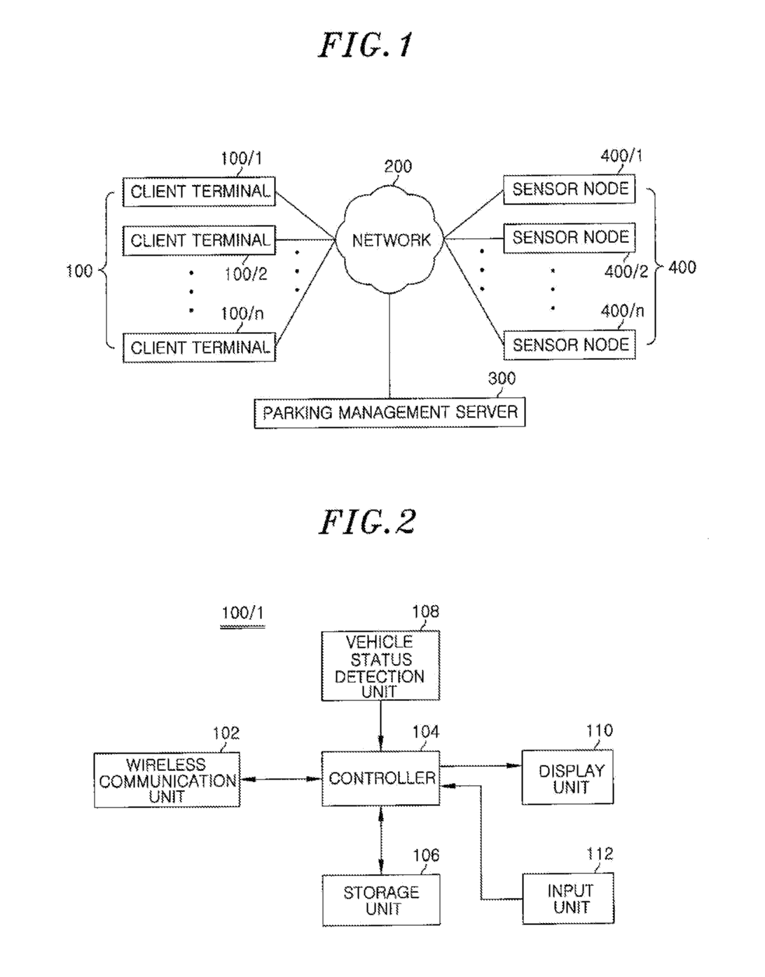

FIG. 1 shows a block diagram of an apparatus for providing a parking management service in accordance with an embodiment of the present invention. The apparatus includes a client terminal group 100, a network 200, a parking management server 300, a sensor node group 400 and the like.

As shown in FIG. 1, the client terminal group 100 includes multiple client terminals 100/1 to 100/n, wherein each client terminal, e.g., the client terminal 100/1 can provide a user terminal environment for providing a parking management service in accordance with an embodiment of the present invention.

The client terminal 100/1 having such a user terminal environment includes a dedicated navigation terminal for providing a parking management server in accordance with an embodiment of the present invention. Alternatively, the client terminal 100/1 may be a wireless terminal having a navigation function. For example, the client terminal 100/1 may include various types of wireless terminals, such as video phones, smart phones, notepads, or the like, in which a navigation function can be installed. A dedicated navigation terminal may be mounted in a vehicle and a wireless terminal having a navigation function may be carried around by a user or may be mounted in a vehicle as necessary.

The client terminal 100/1 uses a wireless communication service for providing a parking management service to a client through interface with a network 200 to be described later. For the wireless communication service, wireless communication protocol transfer protocols, such as Wi-Fi, ZigBee™, UWB (Ultra Wide Band), DSRC (Dedicated Short Range Communication), WAVE (Wireless Access in Vehicular Environment) or the like, may be applied.

Also, the client terminal 100/1 may be applied with a wireless environment supporting broadband wireless communication services, e.g., a second generation (2G) CDMA (Code Division Multiple Access) scheme, a 3G W-CDMA (Wideband Code Division Multiple Access) scheme, or higher wireless communication services for subscribers by interfacing with the network 200 to be described later through a broadband wireless connection. Such broadband wireless communication services are not directly related to the parking management service in accordance with an embodiment of the present invention, so a detailed description thereof will be omitted.

The network 200 includes a local area wireless network, a local area wired network or the like and connects the client terminal group 100, the parking management server 300, and the sensor node group 400 to provide a parking management service in accordance with the embodiment of the present invention.

Here, the local area wireless network, which provides a local area wireless communication environment between the client terminal group 100 and the parking management server 300, includes wireless communication networks such as Wi-Fi, ZigBee™, UWB or the like.

Also, the local area wired network, which provides a local area wired communication environment between the parking management server 300 and the sensor node group 400, may include a wired communication environment such as Ethernet, token-ring, or the like.

The parking management server 300 in accordance with an embodiment of the present invention serves to receive parking available information and vehicle movement information from the sensor node group 400 to be described later wirelessly or through a fixed line through the network 200, and process the same to generate real time parking lot information. Also, the parking management server 300 serves to wirelessly provide parking lot map information, real time parking lot information or the like to the terminal group 100 through the network 200.

The sensor node group 400 is installed in a parking area, a vehicle moving area or the like in a parking lot to recognize a vehicle entering a parking area or vehicles moving in the parking lot and provide the sensing results to the parking management server 300 through the network 200.

FIG. 2 illustrates a detailed block diagram of a client terminal, e.g., the client terminal 100/1, in the client terminal group 100 of the apparatus for providing a parking management service in FIG. 1.

As shown in FIG. 2, the client terminal 100/1 for a parking management service in accordance with an embodiment of the present invention includes a wireless communication unit 102, a controller 104, a storage unit 106, a vehicle status detection unit 108, a display unit 110, an input unit 112 and the like.

First, the wireless communication unit 102 provides a communication environment allowing the client terminal 100/1 to wirelessly communicate with the parking management server 300 through the network 200. For example, the wireless communication unit 102 includes a Wi-Fi communication module, a ZigBee™ communication module, a UWB communication module and the like.

When a vehicle arrives at a parking lot, the wireless communication unit 102 downloads map information on the parking lot or real time parking lot information (parking available information, vehicle movement information or the like) from the parking management server 300. Further, the vehicle transmits status information on a vehicle, e.g., engine status information to the parking management server 300 when the engine of a vehicle parked in a parking area is started.

The controller 104 controls the display unit 110 to display parking lot map information, real time parking lot information or the like which is provided through the wireless communication unit 102. The controller 104 generates parking lot guide information based on the parking lot map information and controls the display unit 110 to display the generated parking lot guide information. Further, when there are several parking areas available, the controller 104 selects an optimum parking area and control the display unit 110 to display the selected optimum parking area.

For example, the controller 104 selects the nearest available parking area, an available parking space including multiple available parking areas, an available parking area in which parking is easy or the like, and displays the same. Also, the controller 104 controls the wireless communication unit 102 to transmit vehicle status information detected through the vehicle status detection unit 108 to be described later, e.g., status information obtained when the engine of the vehicle is started, to the parking management server 300.

The storage unit 106 is managed by the controller 104, and serves to temporarily store parking lot map information, real time parking lot information, or the like, provided through the wireless communication unit 102. The storage information may be used by the controller 104 as necessary.

The vehicle status detection unit 108 detects whether or not the engine of a vehicle has been started, and when the engine of the vehicle is started, the vehicle status detection unit 108 provides corresponding information to the controller 104.

The display unit 110 serves to display parking lot map information, parking lot guide information, real time parking lot information or the like under the control of the controller 104. The display unit 110 includes display means such as an LCD (Liquid Crystal Display), OLED (Organic Light Emitting Diodes) or the like.

The input unit 112 is formed on a front panel or a touch panel of the client terminal 100/1 and generates a key signal corresponding to a key inputted by the user and provides the generated key signal to the controller 104. Here, the key signal includes, e.g., a key signal for selecting an available parking area, a key signal for requesting a route guide and the like.

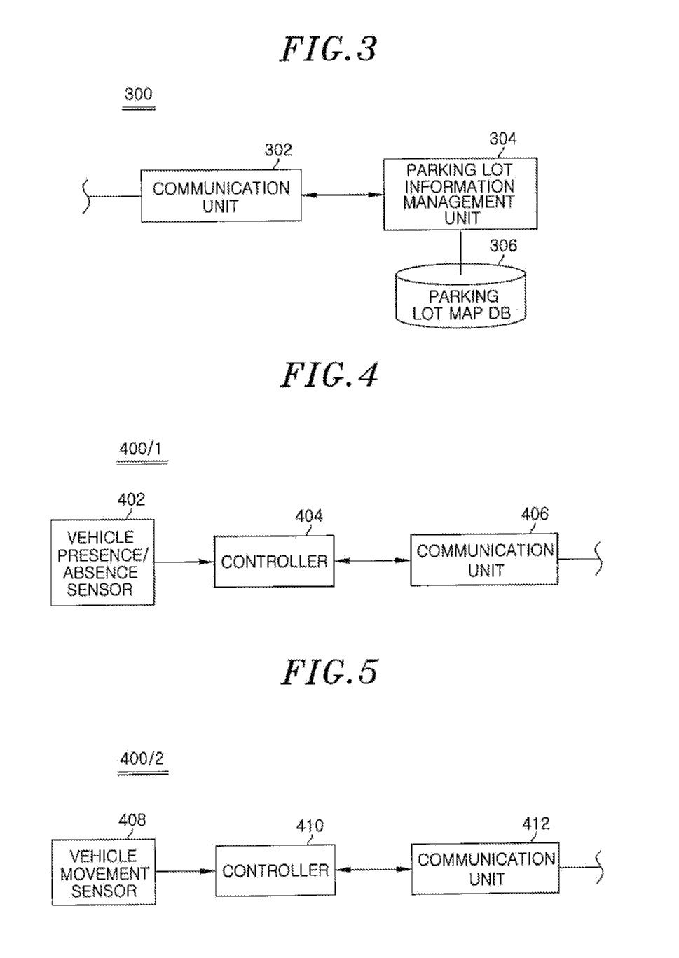

FIG. 3 illustrates a detailed block diagram of the parking management server 300 in FIG. 1, which includes a communication unit 302, a parking lot information management unit 304, a parking lot map DB 306 and the like.

As shown in FIG. 3, the communication unit 302 provides a communication environment between the client terminal group 100 and the sensor node group 200 through the network 200. For example, the communication unit 302 transmits a parking lot map to the client terminal group 100, receives parking available information and vehicle movement information from the sensor node group 200, and transmits real time parking lot information generated by processing the received parking available information and the vehicle movement information to the client terminal group 100.

The parking lot information management unit 304 manages a general service of the parking management server 300. For example, the parking lot information management unit 304 manages the communication unit 302 to transmit a parking lot map to the client terminal group 100, and process parking available information and vehicle movement information received through the communication unit 302 to generate real time parking lot information, and manages the communication unit 302 to transmit the generated real time parking lot information to the client terminal group 100 through the communication unit 302.

The parking lot map DB 306 stores parking lot map information on a parking lot, and the corresponding parking lot map information is selected by the parking lot information management unit 304.

FIG. 4 illustrates a block diagram of a sensor node, e.g., a sensor node 400/1 in the sensor node group 400 of FIG. 1.

The sensor node 400/1 in FIG. 4 includes a vehicle presence/absence sensor 402, a controller 404, a communication unit 406, and the like.

First, the vehicle presence/absence sensor 402 is installed in each parking area of a parking lot to sense a vehicle when the vehicle enters or leaves a parking area. The vehicle presence/absence sensor 402 includes, for example, one or more of an ultrasonic sensor, a geomagnetic sensor, an IR (Infrared Ray) sensor, a light sensor, a color sensor or the like.

The controller 404 controls the communication unit 406 to provide sensing information sensed through the vehicle presence/absence sensor 402 to the parking management server 300. Here, the sensing information is used as parking available information in the parking management server 300. The controller 404 further provides control to receive vehicle status information from the client terminal 100/1 through the communication unit 406 and transmits the received vehicle status information to the parking management server 300 through the communication unit 406 again.

The communication unit 406, which provides a communication environment allowing for communication wirelessly or through a fixed line with the parking management server 300 and the client terminal group 100 through the network 200, includes, e.g., a Wi-Fi communication module, a ZigBee™ communication module, a UWB communication module or wired communication modules such as Ethernet, token-ring and the like.

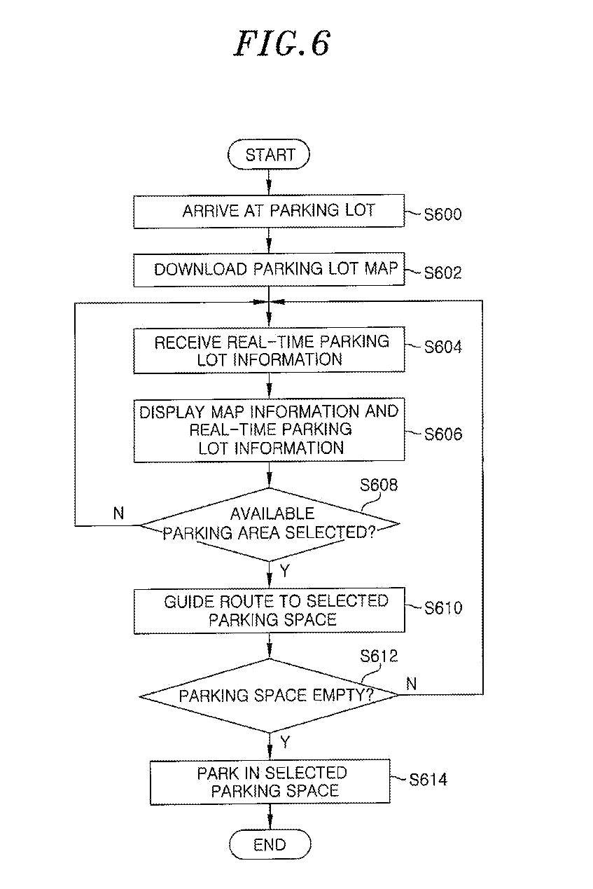

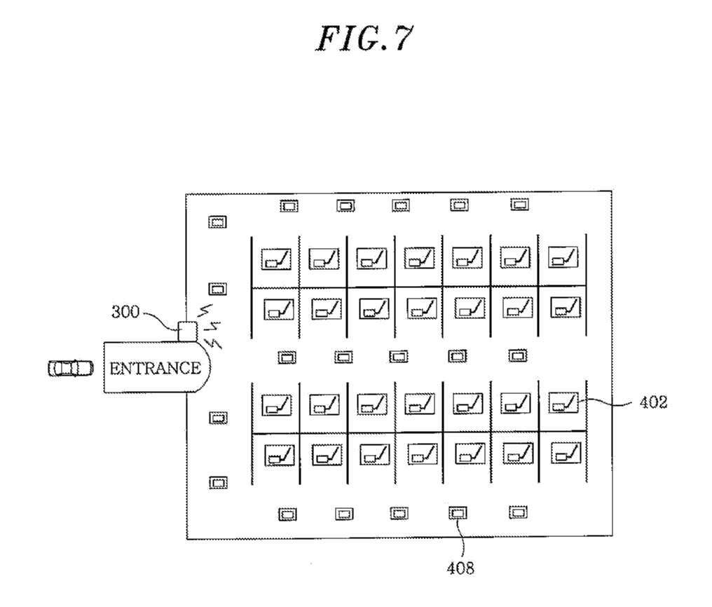

FIG. 5 is a schematic block diagram of a sensor node, e.g., a sensor node 400/2 in the sensor node group of FIG. 1, which includes a vehicle movement sensor 408, a controller 410, a communication unit 412 and the like.

As shown in FIG. 5, the vehicle movement sensor 408 senses a movement of a vehicle within a parking lot. The vehicle movement sensor 408 includes, e.g., one or more of an ultrasonic sensor, a geomagnetic sensor, an IR (Infrared Ray) sensor, a light sensor, a color sensor or the like.

The controller 410 controls the communication unit 412 to provide sensing information sensed through the vehicle movement sensor 408 to the parking management server 300. Here, the sensing information is used as vehicle movement information in the parking management server 300.

The communication unit 412, which provides a communication environment allowing for communication wirelessly or through a fixed line with the parking management server 300 and the client terminal group 100, includes, e.g., a Wi-Fi communication module, a ZigBee™ communication module, a UWB communication module or the like.

FIG. 6 is a flowchart illustrating a parking management process by a client terminal in a method for providing a parking management service in accordance with an embodiment of the present invention.

As shown in FIG. 6, when a specific vehicle, e.g., a vehicle equipped with the client terminal 100/1 arrives at a parking lot in step S600, the client terminal 100/1 requests the parking management server 300 to offer a parking lot map. When the parking management server 300 responds thereto, the client terminal 100/1 downloads the parking lot map from the parking management server 300 in step S602.

Also, the client terminal 100/1 receives real-time parking lot information from the parking management server 300 in step S604, and when the real-time parking lot information is received, the parking lot map and the real-time parking lot information are displayed through the display unit 110 of the client terminal 100/1 in step S606.

FIG. 7 illustrates a parking lot map displayed through the client terminal 100/1, in which the vehicle presence/absence sensor 402, the vehicle movement sensor 408, and the like are displayed at parking areas and vehicle movement routes, as map information regarding the parking lot provided by the parking management server 300 to the client terminal 100/1 at the entrance of the parking lot.

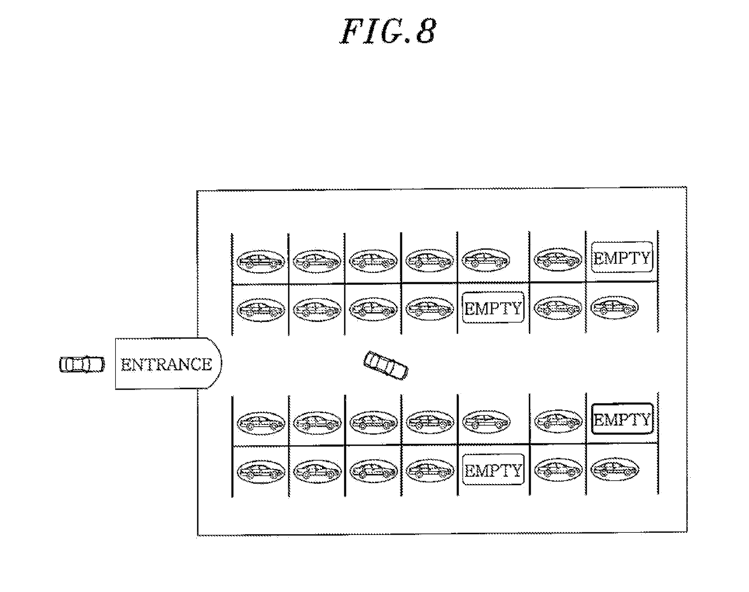

FIG. 8 illustrates real-time parking lot information displayed through the client terminal 100/1. The areas in which other vehicles are currently parked and areas available for parking are shown together, and thus a driver (or a user) can be easily select an available parking area.

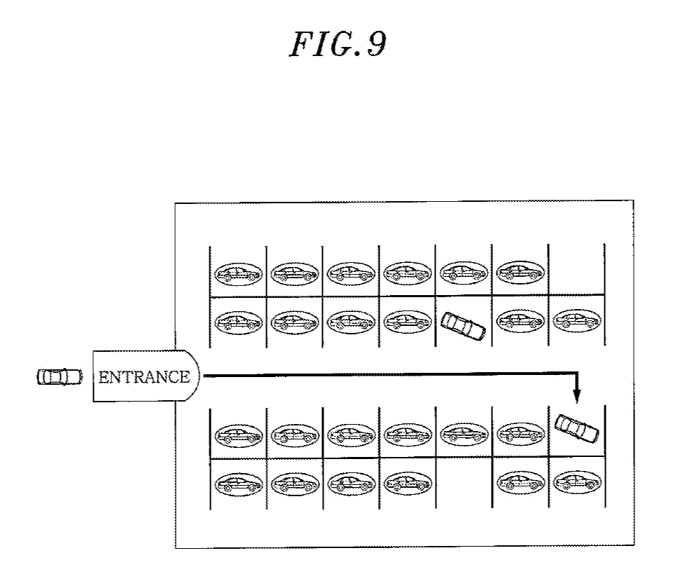

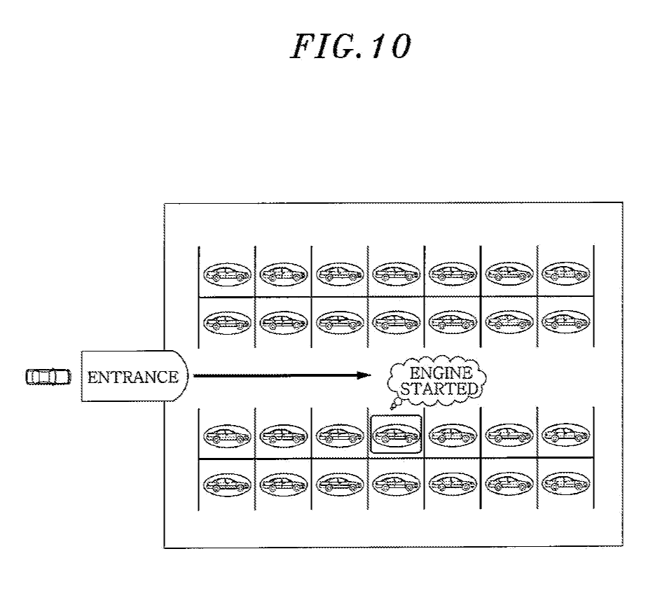

When a certain available parking area (empty area) is selected through the input unit 112 of the client terminal 100/1 in step S608, the controller 104 of the client terminal 100/1 starts to guide a route to the selected available parking area in step S610, as illustrated in FIG. 9.

When the vehicle equipped with the client terminal 100/1 arrives at the available parking area along the route guide, if the parking area is empty, the vehicle can park in the selected available parking area in steps S612 and S614.

Although the driver of the client terminal 100/1 selects the available parking area in the present embodiment, an available parking area, e.g., the nearest one to a current location of the client terminal 100/1 may be recommended under the control of the controller 104.

In step S606, as shown in FIG. 10, a parking area having a high possibility to become available is also displayed on the client terminal 100/1, even when there is no available parking area. For example, when the parking management server 300 receives status information having vehicle engine start information from a certain vehicle including, e.g., the client terminal 100/2, it may be determined that the corresponding vehicle is highly likely to exit soon. Then, the corresponding information is applied into the real time parking lot information to be transmitted to and displayed on the client terminal 100/1.

Accordingly, the driver of the client terminal 100/1 may anticipate that the corresponding vehicle equipped with the client terminal 100/2 will exit shortly, and select the area in which the client terminal 100/2 is parked as an available parking area in step S608.

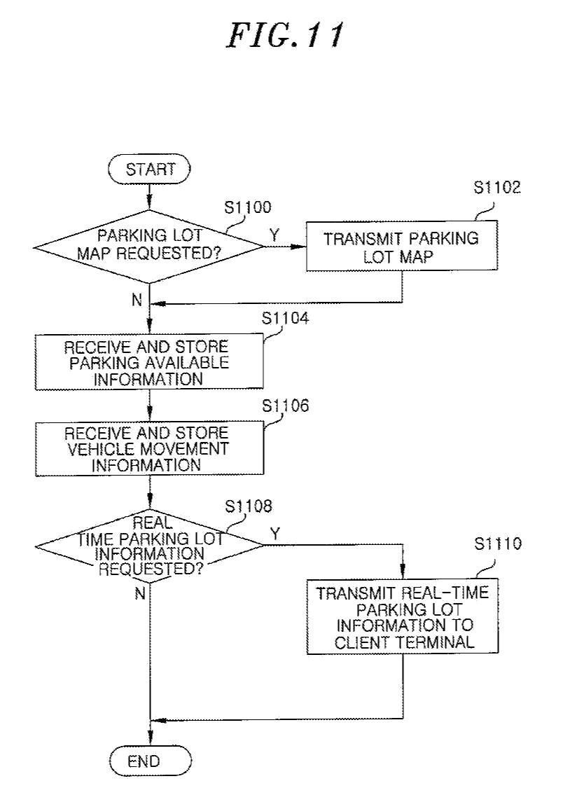

FIG. 11 is a flow chart illustrating a parking management process by the parking management server 300 in the method for providing a parking management service in accordance with an embodiment of the present invention.

As illustrated in FIG. 11, when the vehicle including the client terminal 100/1, arrives at the parking lot, the parking management server 300 determines whether or not a parking lot map is requested by the client terminal 100/1 in step S1100. When a parking lot map is requested, the parking management server 300 transmits a parking lot map stored in its parking lot map DB 306 to the client terminal 100/1 in step S1102.

When the process determining whether the parking lot map is transmitted or not is completed, the parking management server 300 receives parking available information through the vehicle presence/absence sensor 402 of the sensor node group 400 and stores the information in the storage unit 106 in step S1104.

Further, the parking management server 300 receives vehicle movement information through the vehicle movement sensor 408 of the sensor node group 400 and stores the information in the storage unit 106 in step S1106.

Herein, the parking available information and vehicle movement information are stored as real-time parking lot information in the storage unit 106 of the parking management server 300.

Thereafter, when the real-time parking lot information is requested from the client terminal 100/1 in step S1110, the parking management server 300 transmits the real-time parking lot information stored in the storage unit 106 to the client terminal 100/1 in step S1112.

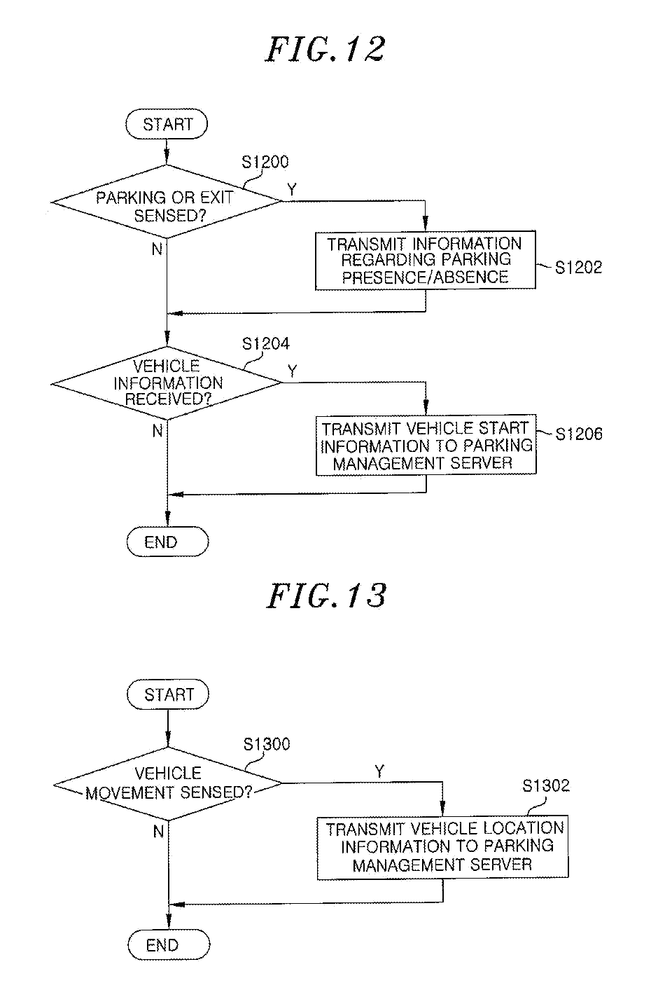

FIG. 12 is a flow chart illustrating a sensing process by the sensor node 400/1 including the vehicle presence/absence sensor 402 in the method for providing a parking management service in accordance with an embodiment of the present invention.

As exemplified in FIG. 12, when there is a vehicle which is parked in the parking lot or exits from the parking lot, the vehicle presence/absence sensor 402 of the sensor node 400/1 senses whether or not the corresponding vehicle is parked or exits in step S1200, and transmits information regarding parking presence/absence to the parking management server 300 through the communication unit 406 in step S1202. Here, the information regarding parking presence/absence may be, e.g., information indicating that parking is not available in case of sensing vehicle parking, or information indicating that parking is available in case of sensing vehicle exit.

Further, it is checked whether or not the sensor node 400/1 receives vehicle status information, e.g., vehicle engine start information, through the communication unit 406 in step S1204. When the vehicle engine start information is received, the controller 404 of the sensor node 400/1 controls the communication unit 406 to transmit the engine start information of the corresponding vehicle to the parking management server 300.

FIG. 13 is a flow chart illustrating a sensing process by the sensor node 400/2 including the vehicle movement sensor 408 in the method for providing a parking management service in accordance with an embodiment of the present invention.

As illustrated in FIG. 13, it is determined whether or not a vehicle movement is sensed by the vehicle movement sensor 408 installed in a vehicle movement area in the parking lot in step S1300.

When a vehicle movement is sensed by the vehicle movement sensor 408, the controller 410 of the sensor node 400/2 controls the communication unit 412 to transmit vehicle movement information depending on the sensing of the vehicle movement to the parking management server 300.

As described above, in accordance with the embodiment of the present invention, a parking management service environment is implemented such that a client terminal and a parking management server are associated through a network in a parking lot to effectively guide an available parking area, and sensor nodes are installed in parking areas and a moving areas in the parking lot to easily recognize a vehicle presence/absence and a vehicle movement. Further, in the embodiment of the present invention, a parking management service environment is implemented such that parking areas in the parking lot and a situation in which other vehicles enter the parking areas are displayed in real time through a client terminal having a navigation function, and a desired parking area can be selected.

As a result, in accordance with the present invention, it is possible to effectively guide a desired parking area even in a complicated and large parking lot by visually proving a large amount of real-time information within the parking lot directly to a vehicle navigation terminal user. Moreover, in accordance with the present invention, since an available parking area can be predicted in advance, a temporal/economical loss taken to search for the parking area can be reduced.

While the invention has been shown and described with respect to the particular embodiments, it will be understood by those skilled in the art that various changes and modification may be made without departing from the scope of the invention as defined in the following claims.

What is claimed is:

1. An apparatus for providing a parking management service comprising:
a client terminal for providing a user with a parking management service in a parking lot by using communication environment;
a first sensor node, installed in a parking area in the parking lot, for sensing whether or not there is a vehicle in the parking area;
a second sensor node, installed at a vehicle movement section in the parking lot, for sensing a vehicle moving in the parking area;
a parking management server for receiving sensing information from the first and second sensor nodes, generating real-time parking lot information by processing the received sensing information, and providing the generated real-time parking lot information to the client terminal; and
a network for transmitting information for a parking management among the client terminal, the first sensor node, the second sensor node and the parking management server.

2. The apparatus of claim 1, wherein the communication environment includes one of Wi-Fi, ZigBee™, a UWB (Ultra Wide Band), DSRC (Dedicated Short Range Communication), WAVE (Wireless Access in Vehicular Environment) and a wired local area network having an Ethernet and a token ring.

3. The apparatus of claim 1, wherein the information for a parking management includes parking lot map information, the sensing information and the real-time parking lot information.

4. The apparatus of claim 1, wherein the real-time parking lot information includes parking available information and vehicle movement information.

5. The apparatus of claim 1, wherein the network includes a local area wireless network or a local area wired network.

6. The apparatus of claim 1, wherein the first sensor node includes a vehicle presence/absence sensor.

7. The apparatus of claim 1, wherein the second sensor node includes a vehicle movement sensor.

8. A client terminal provided in a vehicle for a parking management service comprising:
a communication unit for downloading map information regarding a parking lot or real-time parking lot information and transmitting status information on the vehicle to a parking management server, when the vehicle arrives at the parking lot;
a storage unit for temporarily storing the map information and the real-time parking lot information;
a display unit for displaying the map information, parking lot guide information and/or real-time parking lot information; and
a controller for controlling the display unit to display the map information, real-time parking lot information provided through the communication unit or the parking lot guide information generated based on the map information and controlling the communication unit to transmit the status information to the parking management server.

9. The client terminal of claim 8, wherein the real-time parking lot information includes parking available information and/or vehicle movement information.

10. The client terminal of claim 8, wherein the status information is engine status information when the engine of the vehicle parked in a parking area of the parking lot is started.

11. A server for a parking management service comprising:
a communication unit for providing a communication environment between a client terminal and a first and a second sensor nodes through a network;
a parking lot information management unit for managing the communication unit to transmit a map regarding a parking lot to the client terminal, generating real-time parking lot information by processing parking available information and vehicle movement information received through the communication unit, and managing the communication unit to transmit the generated real-time parking lot information to the client terminal through the communication unit; and
a parking lot map database for storing the map.

12. The server of claim 11, wherein the communication unit transmits a parking lot map to the client terminal, receives parking available information and vehicle movement information from the first and second sensor nodes, respectively, generates real-time parking lot information including the received parking available information and vehicle movement information, and transmits the generated real-time parking lot information to the client terminal.

13. A method for providing a parking management service comprising:
when a vehicle including a client terminal arrives at a parking lot, downloading map information regarding the parking, lot and real-time parking lot information;
displaying the downloaded map information and real-time parking lot information; and
when a certain available parking area is selected based on the real-time parking lot information, starting a route guide to the selected available parking area.

14. The method of claim 13, wherein the real-time parking lot information includes parking available information and vehicle movement information.

15. The method of claim 13, further comprising:
recommending a available parking area within a minimum distance from a location of the client terminal.

16. The method of claim 13, further comprising:
when there is no available parking area in the parking lot, transmitting status information on other vehicles obtained by sensing the information provided therefrom.

17. The method of claim 16, wherein the status information is engine status information when the engine of each of the other vehicles is started.

18. A method for providing a parking management service comprising:
transmitting a parking lot map to a client terminal equipped in a vehicle entering a parking lot;
receiving parking available information and vehicle movement information from sensor nodes installed in a parking area and a vehicle moving area in the parking lot, respectively;
storing the parking available information and vehicle movement information as real-time parking lot information; and
when the real-time parking lot information is requested by the client terminal, transmitting the stored real-time parking lot information to the client terminal.

19. The method of claim 18 wherein the sensor nodes include a vehicle presence/absence sensor and a vehicle movement sensor.

20. The method of claim 19, wherein the sensor nodes include one of an ultrasonic sensor, a geomagnetic sensor, an IR (Infrared Ray) sensor, a light sensor, and a color sensor.
